(19) United States
(12) Patent Application Publication
(10) Pub. No.: US 2026/0260909 A1
(43) Pub. Date: Sep. 3, 2026

(54) ELECTRICAL INTERFACE FOR A FUEL CELL STACK

(71) Applicant: Blue Origin Manufacturing, LLC, Huntsville, AL (US)

(72) Inventors: Matthew Dolan, Renton, WA (US); Benjamin Betteridge, Tacoma, WA (US); Harlan Thomas Kuo, Maple Valley, WA (US)

(21) Appl. No.: 19/067,015

(22) Filed: Feb. 28, 2025

(51) Int. Cl. H01M 8/0202; H01M 8/0247; H01M 8/04537; H01R 12/77; H01R 13/193

(52) U.S. Cl. CPC H01M 8/0269; H01M 8/0247; H01M 8/04552; H01R 12/777; H01R 13/193; H01M 2250/20

(57) ABSTRACT

A system and method are disclosed for establishing electronic connections between a circuit, such as a voltage monitoring circuit, and a fuel cell stack. Each cell in the fuel cell stack comprises an anode and a cathode, with provisions for connecting a voltage measurement device to monitor individual cell outputs. Due to the compact configuration of fuel cell stacks, direct access to these measurement points is often restricted, making traditional connectivity challenging. The connection system, based on a ribbon cable, addresses these constraints by offering a simplified and reliable means of connectivity that minimizes the risk of short-circuiting between closely spaced fuel cell terminals. Furthermore, the system provides enhanced resilience against disconnection due to external forces, such as shock and vibration, ensuring stable performance in environments like those encountered during rocket launches.

### BACKGROUND

Fuel cells are energy devices that generate electricity by an electrochemical process, converting chemical energy directly into electrical energy without combustion. Among the various types, Proton Exchange Membrane Fuel Cells (PEMFCs) are especially well-suited for applications requiring reliable, efficient, and clean power. PEMFCs operate at relatively low temperatures (60-100° C.), which simplifies thermal management and enhances their safety and durability. These fuel cells work by passing hydrogen through an anode, where it splits into protons and electrons. The protons migrate through a polymer membrane to the cathode, while the electrons flow through an external circuit, generating electricity. At the cathode, they combine with oxygen to produce water as the only byproduct, making PEMFCs exceptionally clean and ideal for closed environments like spacecraft.

In crewed spaceflight, PEM fuel cells are highly advantageous due to their compact, lightweight design and ability to reliably produce electrical power. Unlike batteries, which have a limited storage capacity, fuel cells continue to generate power as long as fuel is supplied, making them suitable for extended missions. Though compactness is considered to be among their many benefits, their small size may sometimes present challenges for electrical interfacing.

### SUMMARY

A system and method for electronically connecting a circuit, such as a voltage monitoring circuit, to a fuel cell stack is provided. Each cell within the fuel cell stack includes an anode and a cathode, where a voltage measurement device or circuit may be connected to monitor individual cell performance. The compact size and tightly packed configuration of fuel cell stacks generally make direct access to measurement points, such as anodes and cathodes, challenging. To address this, a ribbon cable-based connection system described herein enables straightforward and secure connectivity that minimizes the risk of short-circuiting the closely spaced fuel cell terminals. Additionally, it provides robust resistance to disconnections that might otherwise occur due to external forces, such as shock and vibration from rocket launches or other dynamic environments.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a schematic diagram of a fuel cell stack configured for voltage measurements, according to some embodiments.

FIG. 2 is a perspective view of a detachable electrical interface for a fuel cell stack, according to some embodiments.

FIG. 3 is a side view of a detachable electrical interface for a fuel cell stack, according to some embodiments.

### DETAILED DESCRIPTION

This disclosure describes a system and method for electronically connecting a circuit, such as a voltage monitoring circuit, to a fuel cell stack. For example, each cell of a fuel cell stack may include an anode and a cathode to which a voltage measuring device or circuit may be applied. Generally, the compact size and configuration of a fuel cell stack preclude relatively easy access to measurement points, such as the anode and cathode, of individual fuel cells.

A fuel cell stack is an assembly of individual fuel cells connected in series to achieve a higher voltage output than a single cell can provide. Each cell within the stack may produce a relatively low voltage (e.g., typically around 0.6-0.8 volts for PEM fuel cells), and stacking them enables scalable power generation to meet various application demands. Monitoring the voltage output of each cell in the stack may be performed to help ensure overall performance, efficiency, and reliability. In a series configuration, a drop in voltage from a single cell, caused by issues like membrane degradation, fuel starvation, or electrode contamination, for example, may significantly impact the performance of the entire stack. By tracking individual cell voltages, underperforming cells may be quickly identified and addressed, preventing issues from escalating and reducing the risk of premature stack failure, among other things. This proactive monitoring may enhance a fuel cell stack's longevity, maintain efficiency, and allow for safe, consistent operation, which may be especially important in critical applications like spaceflight.

The compact design of a fuel cell stack is one of its defining features, allowing for high power density within a small footprint. This is especially beneficial in applications like aerospace, where space and weight are limited. Typical fuel cell stacks can range in size depending on power requirements. But for illustration, a stack generating around 1 kW of power may be only a few inches thick. Each cell in the stack may be relatively thin, such as less than a quarter-inch, for example, and stacked tightly together with minimal spacing for the goal of packing efficiency. As mentioned above, while such a compact design provides high efficiency, it also may present challenges for electrical interfacing and monitoring, particularly when accessing the anodes and cathodes of individual cells for voltage measurement.

The anodes and cathodes of each cell are important measurement points for monitoring voltage, but due to their tight configuration, accessing them without disturbing the stack can be difficult. The small size of each cell means that measurement points are often only millimeters apart, making precise connection challenging. Moreover, any slight misalignment can disrupt connectivity and/or lead to an electrical short. Accordingly, embodiments presented herein address these challenges.

In some embodiments, a detachable electrical interface for a fuel cell stack may include, on the fuel cell stack, a row of receptacle connectors that are individually configured to receive a pin connector, wherein the receptacle connectors in the row alternate between connections to anodes and connections to cathodes of each fuel cell of the fuel cell stack. The interface may also include a ribbon cable that includes parallel conductors, each conductor terminated with a pin connector. A portion of the ribbon cable may be elastically curved so as to provide a compressive force to the pin connectors, substantially in an axial direction of the receptacle connectors on the fuel cell stack. The compressive force may provide a retaining force configured to maintain a position of the connector pin in the receptacle connector. In some implementations, the ribbon cable may include a stiffener layer disposed on a portion of the elastically curved portion so as to increase or otherwise modify the compressive force.

The interface may also include posts that are configured to provide a reactive force to the compressive force so as to maintain position and orientation of the ribbon cable. For example, the ribbon cable may be connected to a printed circuit board (PCB) that includes two or more holes configured to receive the posts. An end of the ribbon cable that terminates at the pin connectors may be called a first end and an opposite end of the ribbon cable that includes the PCB may be called a second end.

In some implementations, the pin connector of each conductor of the ribbon cable may terminate orthogonally to the conductor. In other implementations, the pin connector may terminate the conductor at an angle that is based, at least in part, on a depth of the portion of the ribbon cable that is elastically curved, as described below.

In some implementations, the fuel cell stack may comprise individual fuel cells that are less than about 5 millimeters thick. Each fuel cell may include the connection to the anode and the connection to the cathode of the individual fuel cell.

In other embodiments, an electrical connector system between a monitoring circuit and a fuel cell stack may include a row of receptacle connectors disposed on the fuel cell stack. Each receptacle connector may be configured to receive a pin connector. The receptacle connectors in the row may alternate between connections to anodes and connections to cathodes of the fuel cell stack. The system may also include a ribbon cable comprising parallel insulated wires, each of the wires being terminated with the respective pin connectors at a first end of the ribbon cable. A PCB may be located at a second end, opposite the first end, of the ribbon cable. The PCB may be configured to terminate the parallel insulated wires of the ribbon cable onto rigid conductors of the PCB. The system may also include posts configured to maintain the position and the orientation of the PCB of the ribbon cable. As explained below, a separation distance between a row of the posts and the row of receptacle connectors may be substantially less than a length of the ribbon cable disposed within the separation distance. This difference in distance and length may allow for the ribbon cable to include an elastically curved portion of the ribbon cable, which may provide a compressive force to the pin connectors, substantially in an axial direction of the receptacle connectors. The elastically curved portion of the ribbon cable may have a depth of curvature that is based, at least in part, on a difference in the separation distance and the length of the ribbon cable disposed within the separation distance. In some implementations, the pin connectors may terminate the wires of the ribbon cable at an angle that is based, at least in part, on the depth of curvature of the elastically curved portion of the ribbon cable.

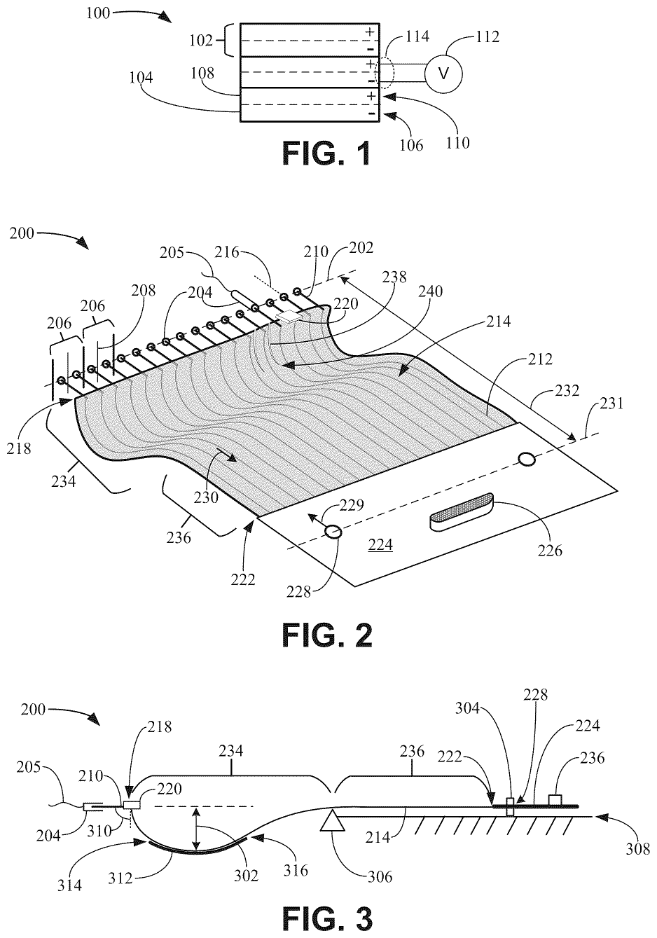

FIG. 1 is a schematic diagram of a fuel cell stack 100 configured for voltage measurements, according to some embodiments. Fuel cell stack 100 may include two or more (three are illustrated) fuel cells 102 stacked in a series configuration. Each fuel cell may include an anode side 104 with an anode terminal 106 and a cathode side 108 with a cathode terminal 110, to which a voltage monitoring/measuring circuit 112 may be connected. Such a connection, indicated by 114 (only one is illustrated, though each fuel cell may include a connection to a circuit 112), may be a detachable electrical interface as described herein.

In each fuel cell 102, oxidation occurs at anode side 104, specifically where hydrogen molecules split into protons and electrons. The electrons generate flow out of anode terminal 106, creating an electrical current. Reduction occurs at cathode side 108. Protons from the anode move through an electrolyte to the cathode, where they combine with oxygen and electrons to form water. Accordingly, cathode terminal 110 receives electrons from the external circuit, which may be voltage monitoring/measuring circuit 112 in this example.

FIG. 2 is a perspective view of a detachable electrical interface 200 for a fuel cell stack, according to some embodiments. For example, the fuel cell stack may be the same as or similar to 100. Electrical interface 200 may include a row 202 of receptacle connectors 204 that are part of the fuel cell stack. An electrical conductor 205 may lead from each receptacle connector 204 to an interior portion of a fuel cell (e.g., anode side 104 or cathode side 108). In some implementations, one receptacle connector 204 may correspond to an anode terminal (e.g., 106) of an anode side (e.g., 104) of a fuel cell 206 of the stack. Similarly, one receptacle connector 204 may correspond to a cathode terminal (e.g., 110) of a cathode side (e.g., 108) of a fuel cell. An interface 208 between the anode side and the cathode sides of fuel cells 206 is schematically illustrated as an example of how each fuel cell 206 may have an anode side and a cathode side.

Electrical interface 200 may also include a row of pins 210, each terminating a corresponding electrical conductor (e.g., wire) 212 of a ribbon cable 214. Pins 210 may be configured to insert into receptacle connectors 204. Each pin 210 may correspond to a single receptacle connector 204. In first implementations, each pin 210 may be inserted in a single receptacle connector 204 so as to make an electrical connection. In second implementations, pins 210 need not (yet) be inserted in receptacle connectors 204. The differences between the first and the second implementations are based on whether or not electrical interface 200 is engaged to make an electrical connection or unattached and in a state of preparedness for attachment, for example. Claimed subject matter is not limited to either of these implementations.

Ribbon cable 214 may be a flat, flexible cable made up of multiple conductors 212 running parallel to one another. Conductors 212 may be relatively small-gauge wires configured to carry electrical signals or current, for which a voltage may be measured (e.g., by circuit 112). Conductors 212 may be insulated with a flexible material, like PVC, Capton, or Teflon, just to name a few examples. The flat, wide profile of ribbon cable 214 allows it to be folded or elastically curved so as to provide a restorative force that attempts to return the ribbon cable back to its original (e.g., flat) shape. This force generally arises from the ribbon cable's elastic properties. In embodiments, relative positioning and orientation of row 202 of receptacle connectors 204 and pins 210, which terminate conductors 212 of ribbon cable 214, may lead to the restorative force being applied to pins 210 in a general direction of the axes 216 of the receptacle connectors.

In some implementations, at a first end 218 of ribbon cable 214, pins 210 may terminate individual conductors 212 in a connector housing 220, only one of which is schematically illustrated. In some implementations, connector housing 220 may be partitionable so that distances between individual pins 210 may be increased so as to address positioning tolerance issues, which is further described below. At a second end 222 of ribbon cable 214, conductors 212 may terminate at a PCB 224. For example, ribbon cable 214 may be directly attached to PCB 224 for secure termination and relative ease of integration into a larger circuit, such as via a connector 226. For example, connector 226 (e.g., a plug or receptacle D-sub connector) of PCB 224 may be a socket or header that the ribbon cable's pins 210 terminate into, allowing for detachment and reattachment at connector 226.

PCB 224 may include holes or openings 228 that are configured to receive respective posts (not illustrated in FIG. 2) from below or above PCB 224. The posts may be configured to provide a reactive force 229 to a compressive force 230, as described below, so as to maintain position and orientation of the ribbon cable. Openings 228 may be aligned in a row 231, which may be a distance 232 from row 202 of receptacle connectors 204. A significance of distance 232 is explained below.

As discussed above, the flat, wide profile of ribbon cable 214 allows it to be folded or elastically curved so as to provide a restorative force that attempts to return the ribbon cable back to its original (e.g., flat) shape. Accordingly, electrical interface 200 may include an elastically curved portion 234 that results in a restorative force arising from the ribbon cable's elastic properties. Relative positioning and orientation of receptacle connectors 204 and pins 210 may lead to the restorative force being applied to pins 210 in a general direction of axes 216 of the receptacle connectors. This provides a retaining force that may help to hold pins 210 inside receptacle connectors 204 for a secure electrical connection. Curved portion 234 may lead to a relatively straight or flat portion 236, which may extend between the curved portion and PCB 224, for example. In some implementations, flat portion 236 need not be present such that curved portion 234 may lead directly into PCB 224.

In some embodiments, a length of ribbon cable 214 and portions thereof may be configured to establish various characteristics of curved portion 234, such as its depth, width, and radius of curvature, for example, which may in turn lead to a desired restorative force. These characteristics are discussed below. Among these characteristics for establishing a restorative force, distance 232 may also play a role.

In some implementations, adjacent conductors 212 may be separated from each other by a split 238 in the inter-conductor ribbon material (e.g., the insulation). Such a split may allow for pins 210 of conductors 212 associated with a split to connect to receptacle connectors 204 that may not be evenly spaced in row 202. In other words, split 238 may allow for positioning tolerance issues associated with placements of receptacle connectors 204 in row 202 and/or pins 210 of ribbon cable 214 at first end 218. In some case, split 238 may extend from first end 218 to a terminus 240 by up to about 12 millimeters. In other words, the parallel conductors 212 of ribbon cable 214 may be divided from one another within about 12 millimeters of the pins, though claimed subject matter is not limited this length.

FIG. 3 is a side view of detachable electrical interface 200, illustrating a depth of curvature 302 of elastically curved portion 234 of ribbon cable 214. As explained above, the elastically curved portion may provide a compressive force to pins 210, substantially in axial direction 216 of receptacle connectors 204. Depth of curvature 302 may be based on how much the ribbon cable is “compressed” to create the curved portion. Specifically, for example, depth of curvature 302 may be based, at least in part, on a difference in the separation distance 232 and the length of the ribbon cable disposed within the separation distance.

The length of ribbon cable may be defined as the length one measures by following, along the ribbon cable, curved portion 234 and flat portion 236 between first end 218 and second end 222 of the ribbon cable, though other points of reference, such as row 231, may be considered, and claimed subject matter is not limited to any particular definition for the length of ribbon cable. PCB 224 may be held securely in place by posts 304 that penetrate openings 228 in the PCB, providing its stability and alignment. Curved portion 234 may be created if the distance between posts 304 holding PCB 224 and first end 218 of the ribbon cable is shorter than the length of the ribbon cable. The curvature is not due to slack (e.g., looseness of the ribbon cable) but may be an intentional feature that accommodates the difference in distance while presenting a force of retention that may help to hold pins 210 in receptacle connectors 204.

In a configuration that includes a gap that allows curved portion 234 to form, the shape of curved portion 234, such as its depth 302 and radius of curvature, may be determined by the elasticity and stiffness of the ribbon cable material. For example, the cable's elasticity allows it to bend smoothly rather than remaining rigid, while its stiffness determines how tightly or gently the curve forms. A more flexible cable may exhibit a tighter curve, whereas a stiffer cable may create a larger, more gradual bend. The gap may extend from first end 218 to an edge or support point 306 of a support 308 for flat portion 236. Support 308, to which support posts 304 may be affixed, may also support PCB 224. In some implementations, second end 222, corresponding to an edge of PCB 224 and an end of ribbon cable 214, may coincide with support point 306 such that flat portion 236 is not present in interface 200.

In some implementations, pins 210 may terminate conductors 212 of ribbon cable 214 at an angle 310 that is based, at least in part, on depth of curvature 302 of the elastically curved portion 234 of the ribbon cable. The depth of curvature may determine, in part, the slope at which conductors 212 approach pins 210. For example, for a depth of curvature of zero (e.g., no curved portion), pins 210 may be in line (e.g., 180 degrees) with end portions of conductors 212. As the depth increases from zero, angle 310 may decrease while pins 210 maintain an alignment with axes 216. For a substantial depth of curvature (such as that illustrated), pins 210 may be orthogonal (e.g., 90 degrees) to conductors 212. In some implementations, angle 310 may be accommodated or fixed by connector housing 220, which may securely fix pins 210 to conductors 212. The pins and end portions of the conductors may be embedded in the material of housing 220, for example. Depth of curvature 302 and/or the shape of elastically curved portion 234 may be affected by angle 310 if this angle is fixed by housing 220. Accordingly, in summary, features that may affect the depth of curvature and/or shape of elastically curved portion 234 may include relative positioning of support point 306, angle 310 if it is rigidly fixed by housing 220 or receptacle connectors 204, length of ribbon cable 214 relative to distance 232, and elasticity of ribbon cable 214, just to name a few examples.

In some embodiments, ribbon cable 214 may include a stiffener layer 312 disposed on the ribbon cable in at least a portion of elastically curved portion 234. For example, stiffener layer 312 may terminate at a first end 314 and/or a second end 316 within portion 234. In some implementations, first end 314 may be at or near housing 220 and second end 316 may be at or near support point 306. Stiffener layer 312 may be added to ribbon cable 214 to modify depth of curvature 302 and/or the shape of elastically curved portion 234, which may in turn modify a force of retention applied to pins 210 in receptacle conductors 204, for example. Stiffener layer 312 may be a plastic or a thin metal material that may or may not be elastic. In implementations where stiffener layer is not elastic, the distance between first end 314 and second end 316 may likely be relatively short so as to not excessively limit an overall flexibility of curved portion 234.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A detachable electrical interface for a fuel cell stack, the detachable electrical interface comprising:
a row of receptacle connectors, individually configured to receive a pin connector, wherein the receptacle connectors in the row alternate between connections to anodes and connections to cathodes of the fuel cell stack;
a ribbon cable including parallel conductors, each conductor terminated with the pin connector, wherein a portion of the ribbon cable is elastically curved so as to provide a compressive force to the pin connectors, substantially in an axial direction of the receptacle connectors; and
posts configured to provide a reactive force to the compressive force so as to maintain position and orientation of the ribbon cable.

2. The electrical interface of claim 1, wherein the pin connector terminates orthogonally to the conductor.

3. The electrical interface of claim 1, wherein the pin connector terminates the conductor at an angle that is based, at least in part, on a depth of the portion of the ribbon cable that is elastically curved.

4. The electrical interface of claim 1, wherein the posts are affixed on an electrical printed circuit board (PCB) that underlies the ribbon cable.

5. The electrical interface of claim 1, wherein a first end of the ribbon cable terminates at the pin connectors and a second end, opposite the first end, of the ribbon cable includes a PCB.

6. The electrical interface of claim 5, wherein the PCB of the ribbon cable includes holes that are configured to receive the posts.

7. The electrical interface of claim 1, wherein the fuel cell stack comprises individual fuel cells that are less than about 5 millimeters thick, each fuel cell including the connection to the anode and the connection to the cathode of the individual fuel cell.

8. The electrical interface of claim 1, wherein the parallel conductors of the ribbon cable are divided from one another within about 12 millimeters of the pin connectors.

9. The electrical interface of claim 1, wherein a separation distance between a row of the posts and the row of receptacle connectors is substantially less than a length of the ribbon cable disposed in the separation distance.

10. The electrical interface of claim 1, wherein the compressive force provides a retaining force configured to maintain a position of the connector pin in the receptacle connector.

11. The electrical interface of claim 1, wherein the ribbon cable further includes a stiffener layer disposed on the ribbon cable in at least a portion of the elastically curved portion.

12. An electrical connector system between a monitoring circuit and a fuel cell stack, the electrical connector system comprising:
a row of receptacle connectors disposed on the fuel cell stack, each receptacle connector configured to receive a pin connector, wherein the receptacle connectors in the row alternate between connections to anodes and connections to cathodes of the fuel cell stack;
a ribbon cable including parallel insulated wires, each of the wires terminated with the respective pin connectors at a first end of the ribbon cable;
a PCB at a second end, opposite the first end, of the ribbon cable, the PCB configured to terminate the parallel insulated wires onto rigid conductors on the PCB; and
posts configured to maintain position and orientation of the PCB of the ribbon cable, wherein a separation distance between a row of the posts and the row of receptacle connectors is substantially less than a length of the ribbon cable disposed within the separation distance.

13. The electrical connector system of claim 12, further comprising an elastically curved portion of the ribbon cable that provides a compressive force to the pin connectors, substantially in an axial direction of the receptacle connectors.

14. The electrical connector system of claim 13, wherein the ribbon cable further comprises a stiffener layer disposed on the ribbon cable in at least a portion of the elastically curved portion.

15. The electrical connector system of claim 13, wherein the elastically curved portion of the ribbon cable has a depth of curvature that is based, at least in part, on a difference in the separation distance and the length of the ribbon cable disposed within the separation distance.

16. The electrical connector system of claim 15, wherein the pin connectors terminate the wires of the ribbon cable at an angle that is based, at least in part, on the depth of curvature of the elastically curved portion of the ribbon cable.

17. The electrical connector system of claim 12, wherein the pin connectors terminate orthogonally to the wires of the ribbon cable.

18. The electrical connector system of claim 12, wherein the fuel cell stack comprises individual fuel cells that are less than about 5 millimeters thick, each fuel cell including the connection to the anode and the connection to the cathode of the individual fuel cell.

19. The electrical connector system of claim 12, wherein the parallel conductors of the ribbon cable are divided from one another within about 12 millimeters of the pin connectors.

20. The electrical connector system of claim 12, wherein the ribbon cable comprises Kapton or Teflon insulation among the parallel insulated wires.
